(19) United States
(12) Patent Application Publication
(10) Pub. No.: US 2026/0117853 A1
(43) Pub. Date: Apr. 30, 2026

(54) TRANSMISSION FOR A VEHICLE AND METHOD OF ASSEMBLING THEREOF

(71) Applicant: BRP-ROTAX GMBH & CO. KG, Gunskirchen (AT)

(72) Inventor: Andreas MATHEIS, Tettenweis (DE)

(21) Appl. No.: 19/371,440

(22) Filed: Oct. 28, 2025

Related U.S. Application Data
(60) Provisional application No. 63/714,370, filed on Oct. 31, 2024.

(51) Int. Cl. F16H 57/028; F16B 33/00; F16H 57/02; F16H 57/021; F16H 57/023; F16H 57/031; F16H 57/032

(52) U.S. Cl. CPC F16H 57/028; F16B 33/00; F16H 57/021; F16H 57/023; F16H 57/031; F16H 57/032; F16B 2200/83; F16H 2057/02043

(57) ABSTRACT

A transmission for a vehicle and a method of assembly. The transmission includes a housing body having a body connection surface, a housing cover having a cover connection surface, a friction-enhancing insert, and a magnetic threaded fastener fastened to the body such that a portion is disposed in a volume defined between the body and the cover. The cover is connected to the body such that the body connection surface faces the cover connection surface with the insert compressed therebetween. The insert has a compressible body with a first surface contacting the cover connection surface and a second surface contacting the body connection surface. Particles are disposed on the first surface. The particles being harder than a material of the body and the cover. When the insert is compressed at least some of the particles penetrate the compressible body, the body connection surface, and the cover connection surface.

### CROSS-REFERENCE

The present application claims priority to U.S. Provisional Application No. 63/714,370, filed on Oct. 31, 2024, which is incorporated herein by reference in its entirety.

### TECHNICAL FIELD

The present technology relates to a transmission having a friction-enhancing insert, and to a method for assembling said transmission.

### BACKGROUND

In many assemblies where two components are assembled together such that surfaces of the components abut each other, forces acting on the assembly can cause the components to move slightly relative to each other along the abutting surfaces. These forces can be due, for example, from one or more of tension, compression and torsion of the assembly and/or from vibrations. In some assemblies, these movements are undesirable.

For example, a transmission has a housing body and a housing cover connected to the housing body via multiple bolts. Shafts of the transmission mechanism pass through openings in the housing body and the housing cover. These shafts are supported in the housing body and the housing cover by bearings. Forces acting on the shafts are transferred to the bearings which can lead to small movements of the housing cover relative to the housing body. These small movements result in movements of the bearings which could lead to premature bearing failures. These small movements could also lead to premature failure of gears supported by the shafts.

One solution to the above problem consists in increasing the clamping force between the housing body and the housing cover of the transmission. For example, this can be achieved by using larger diameter bolts and/or more bolts to connect the housing body and the housing cover together. However, this increases the weight and complexity of the assembly of the housing body and the housing cover.

An alternative solution to the above problem consists in increasing the friction between the housing body and the housing cover. This can be achieved by coating the abutting surface of either the housing cover or the housing body with a friction-enhancing coating prior to assembly. In some cases, the friction-enhancing coating is applied around apertures defined in one of the housing body and the housing cover. The friction-enhancing coating consists of hard particles and other elements for bonding the hard particles to the surface. When the housing body and the housing cover are connected together, the clamping force between them causes the particles of the friction-enhancing coating to penetrate the abutting surfaces. As a result, the relative movement between the housing body and the housing cover is reduced.

However, when using a friction-enhancing coating, some of the particles can detach from the surface to which they are applied while handling during assembly. As these particles are hard, the detached particles could potentially damage some other components of the transmission. For example, particles that come off of the housing cover can fall to a bottom of the transmission during assembly. Once the transmission is assembled, lubricant is added inside the transmission and accumulates at the bottom of the transmission. During operation of the transmission, the particles that fell to bottom of the transmission can get entrained with the lubricant. These entrained particles could make their way to gears or bearings of the transmission, and as a result these gears and bearings could be damaged.

Therefore, there is a desire for a transmission and a method for assembling the transmission that can overcome at least some of the above-described drawbacks.

### SUMMARY

It is an object of the present technology to ameliorate at least some of the inconveniences present in the prior art.

According to one aspect of the present technology, there is provided a transmission. The transmission including a housing body having a body connection surface; a housing cover having a cover connection surface, the housing cover connected to the housing body such that the body connection surface faces the cover connection surface; a friction-enhancing insert having a compressible body having a first surface contacting one of the body connection surface and the cover connection surface; a second surface contacting an other one of the body connection surface and the cover connection surface; and particles, the particles being disposed on at least a portion of the first surface prior to the friction-enhancing insert being compressed, the particles being harder than a material of the housing body and the housing cover; the friction-enhancing insert being compressed between the body connection surface and the cover connection surface such that at least some of the particles penetrate the compressible body, the body connection surface, and the cover connection surface; and at least one magnetic threaded fastener fastened to at least one of the housing body and the housing cover, a portion of at least one magnetic threaded fastener being disposed in a volume defined between the housing body and the housing cover.

In some embodiments, the first surface contacts the cover connection surface; and the second surface contacts the body connection surface.

In some embodiments, the material of the housing body and the material of the housing cover are aluminum; and the particles are steel particles.

In some embodiments, the body connection surface defines a body aperture; the cover connection surface defines a cover aperture; the friction enhancing insert defines an insert aperture extending between the first surface and the second surface; the insert aperture, the body aperture, and the cover aperture being aligned with one another; and the transmission further includes a fastener inserted through the cover aperture, the body aperture, and the insert aperture, thereby fastening the housing cover to the housing body.

In some embodiments, the friction-enhancing insert is a ring.

In some embodiments, an adhesive coating is applied to at least the portion of the first surface and the particles are adhered to the adhesive coating.

In some embodiments, the first surface includes an adhesive applied to at least a part of the first surface to adhere the first surface to the one of the body connection surface and the cover connection surface.

In some embodiments, the transmission further includes a bearing received in at least one of the housing body and the housing cover; and a shaft supported by the bearing; a material of the bearing and a material of the shaft are as hard or harder than the particles.

In some embodiments, the at least one magnetic threaded fastener is two magnetic threaded fasteners.

In some embodiments, the portion of the at least one magnetic threaded fastener is at an end of the at least one magnetic threaded fastener.

According to another aspect of the present technology, there is provided a method of assembling a transmission of a vehicle. The method includes providing a housing body of the transmission, the housing body having a body connection surface; providing a housing cover of the transmission, the housing cover having a cover connection surface; positioning a first surface of a friction-enhancing insert to contact one of the body connection surface and the cover connection surface, the friction-enhancing insert having a compressible body, the first surface having particles, the particles being disposed on at least a portion of the first surface, the particles being harder than a material of the housing body and the housing cover; connecting the housing body and the housing cover such that a second surface of the friction-enhancing insert contacts an other one of the body connection surface and the cover connection surface; compressing the friction-enhancing insert such that at least some of the particles penetrate the compressible body, the body connection surface, and the cover connection surface; and fastening at least one magnetic threaded fastener to at least one of the housing body and the housing cover, such that a portion of the at least one magnetic threaded fastener is disposed in a volume defined between the housing body and the housing cover.

In some embodiments, the first surface contacts the cover connection surface; and the second surface contacts the body connection surface.

In some embodiments, the method further includes applying an adhesive to at least a part of the first surface of the friction-enhancing insert, such that the adhesive adheres to the one of the body connection surface and the cover connection surface.

In some embodiments, the body connection surface defines a body aperture; the cover connection surface defines a cover aperture; the friction-enhancing insert defines an insert aperture extending between the first surface and the second surface; the positioning the first surface of the friction-enhancing insert to contact one of the body connection surface and the cover connection surface includes aligning the insert aperture with the body aperture and the cover aperture; and the connecting the housing body and the housing cover includes inserting a fastener through the cover aperture, the insert aperture, and the body aperture; and fastening the housing cover to the housing body with the fastener.

In some embodiments, the fastening at least one magnetic threaded fastener to at least one of the housing body and the housing cover includes fastening two magnetic threaded fasteners to at least one of the housing body and the housing cover.

In some embodiments, the portion of the at least one magnetic threaded fastener is at an end of the at least one magnetic threaded fastener.

In some embodiments, the method further includes placing a bearing in at least one of the housing body and the housing cover; and inserting a shaft into the bearing; wherein a material of the bearing and a material of the shaft are as hard or harder than the particles.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a transmission in accordance with the present technology;

FIG. 2 is a right side elevation view of a housing cover of the transmission of FIG. 1;

FIG. 3 is a close-up perspective view of section A of the housing cover of FIG. 2;

FIG. 4 is a perspective view of an insert of the transmission of FIG. 1;

FIG. 5 is a schematic cross-section of the housing cover of FIG. 1 taken through line 5-5 of FIG. 3;

FIGS. 6A to 6D are schematic representations of a method of assembling the housing cover with a housing body of the transmission of FIG. 1;

FIG. 7 is a perspective view taken from a top, rear, right side of the transmission of FIG. 1;

FIG. 8 is a partially exploded perspective view of the housing body taken from a bottom, rear, right side of the transmission of FIG. 1;

FIG. 9 is a cross-sectional view of a portion of the transmission of FIG. 1 taken through line 9-9 of FIG. 7; and

FIG. 10 is a flow chart of a method of assembling the transmission.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

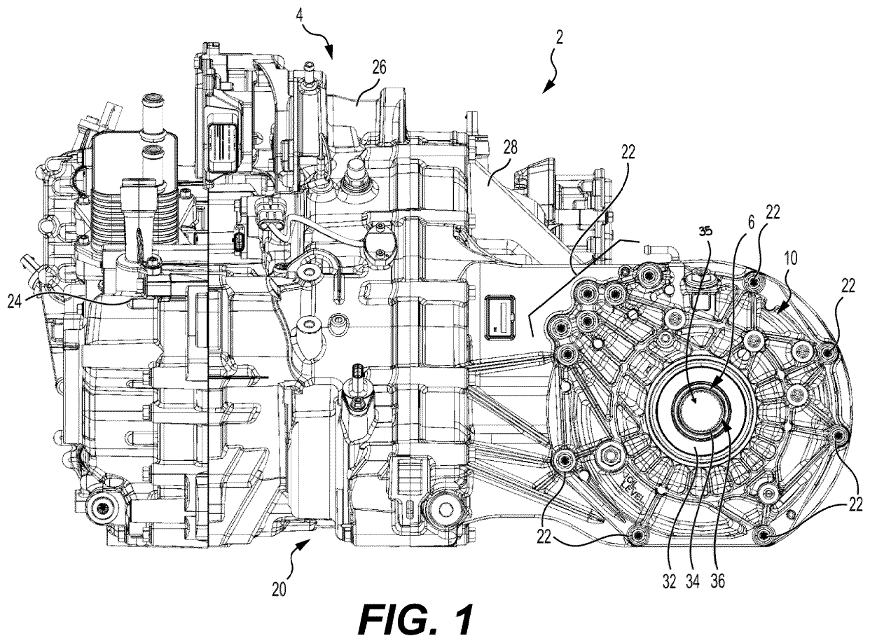

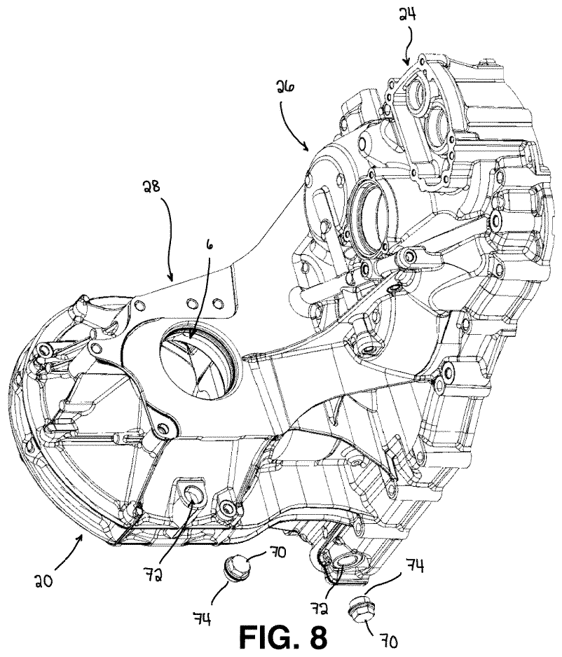

A transmission 2, in accordance with the present technology will be described with reference to FIGS. 1 to 9. The transmission 2 has a mechanical housing, specifically a transmission housing 4, inside which various mechanical components (not shown) of the transmission are housed. The transmission 2 has transmission outputs 6 on either side thereof. In the present embodiment, the transmission outputs 6 are configured to operatively connect tot axles of a road vehicle. The transmission housing 4 has a housing cover 10 fastened to a housing body 20 by multiple fasteners 22. In the present embodiment, the fasteners 22 are bolts 22.

The housing body 20 has a front section 24, a middle section 26, and a rear section 28. The sections 24 and 26 are fastened to each other. The sections 26 and 28 are fastened to each other. The housing cover 10 is fastened to the rear section 28 of the housing body 20 to close an opening (not shown) defined in a left side of the rear section 28. The housing cover 10 defines an aperture 30. The transmission output 6 includes a bearing 32, a sleeve 34 having internal splines 36, and a shaft 35 supported by the bearing 32 and sleeve 34. The bearing 32 is placed in the aperture 30. The sleeve 34 is inserted in the bearing 32. The shaft 35 is inserted into the bearing 32 and the sleeve 34. It is contemplated that the housing body could have more or less than the three sections 24, 26, 28.

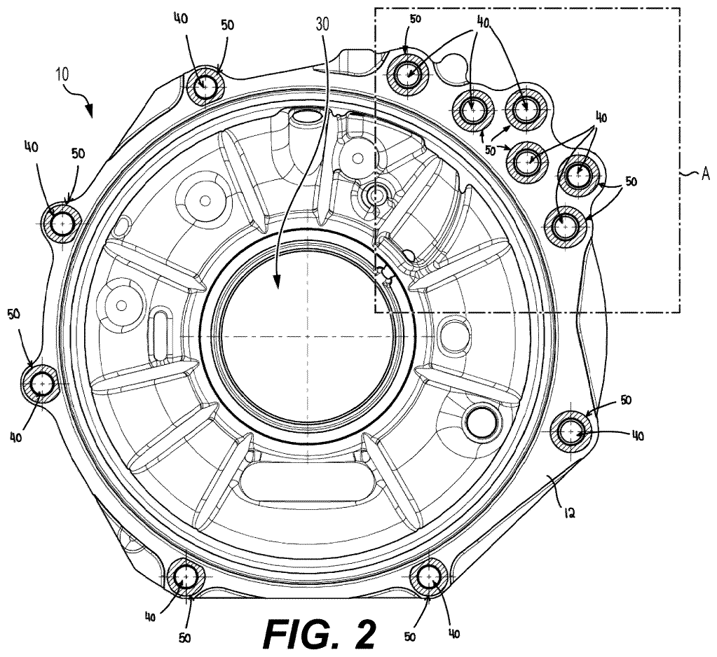

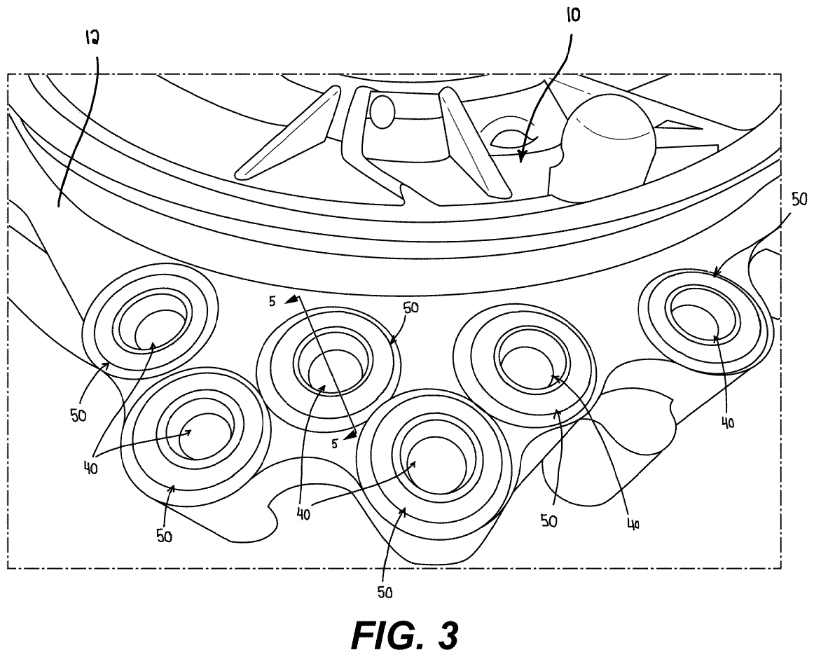

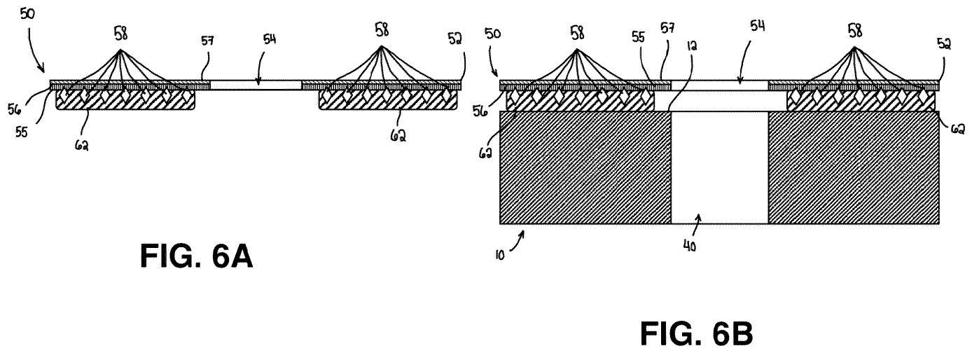

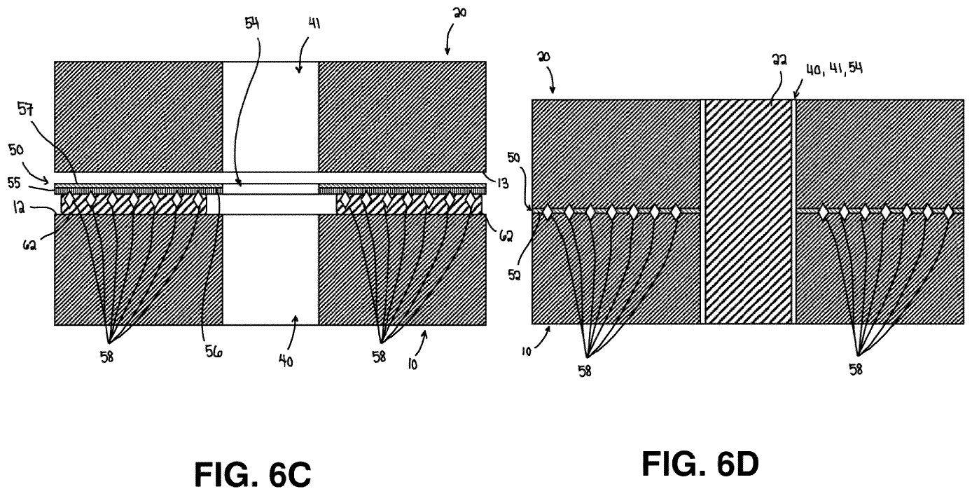

With reference to FIGS. 2 and 3, the housing cover 10 has a cover connection surface 12, hereinafter connection surface 12, that faces and abuts with a corresponding body connection surface 13 (shown schematically in FIGS. 6C and 6D), hereinafter connection surface 13, on the rear section 28 of the housing body 20. For each fastener 22, the housing cover 10 defines a cover aperture 40 in the connection surface 12. The rear section 28 of the housing body 20 defines a corresponding body aperture 41 (as depicted schematically in FIGS. 6C and 6D) in the connection surface 13 of the rear section 28. Multiple friction-enhancing inserts 50 (hereinafter inserts 50) are disposed between the connection surface 12 of the housing cover 10 and the connection surfacer 13 of the rear section 28 of the housing body 20, thereby increasing the friction between the connection surface 12 of the housing cover 10 and the connection surface 13 of the rear section 28 of the housing body 20. It is contemplated that any number of friction-enhancing inserts 50 may be disposed between the housing cover 10 and the housing body 20.

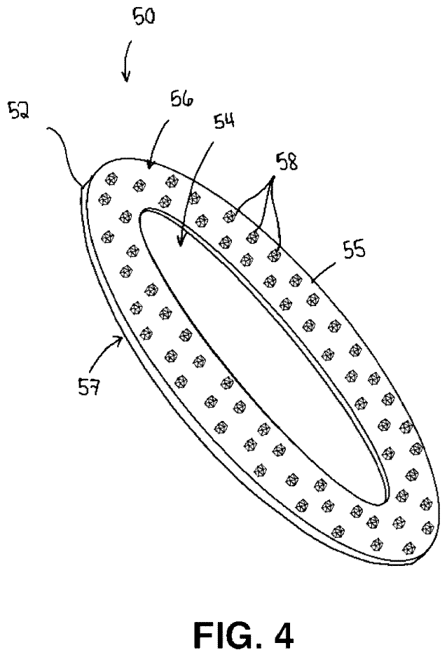

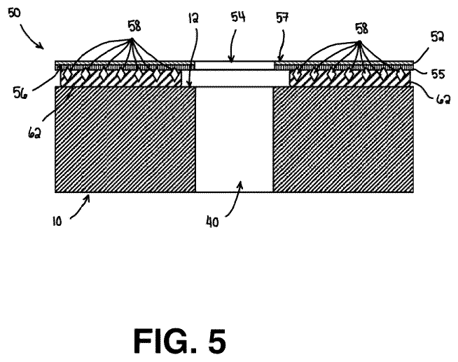

With reference to FIGS. 4 and 5, the inserts 50 will now be described in detail. Each of the inserts 50 are configured the same and therefore, for clarity, only a single insert 50 will be described. The insert 50 includes a body 52 composed of a compressible material. When placed in between the connection surface 12 of the housing cover 10 and the connection surface 13 of the rear section 28 of the housing body 20, and the housing cover 10 is connected to the housing body 20, the insert 50 is compressed. In this embodiment, the body 52 is composed of unwoven fabric, however it is contemplated that any other suitable material may be used. The body 52 defines an insert aperture 54 extending therethrough, such that the body 52 forms a ring. It is contemplated that the body 52 may be shaped differently in different embodiments.

The insert 50 includes a surface 56 with an adhesive coating 55 to which particles 58 are applied, thereby increasing the friction of the surface 56 to form a friction surface. A surface 57 of the insert 50 opposite the surface 56 is particle-free. It is noted that the particles 58 may be applied to the surface 56 differently in different embodiments. In this embodiment, the adhesive coating 55 and the particles 58 are applied to the entire surface 56. It is contemplated that, in alternative embodiments, the adhesive coating 55 and the particles 58 may be applied differently, for example, the adhesive coating 55 and the particles 58 may be applied over a portion of the surface 56 or over multiple annulus sectors around the insert aperture 54. In other embodiments, both surfaces 56, 57 may be friction surfaces which include the particles 58.

The particles 58 are composed of a material that is harder than a material of the surface between which the insert 50 is sandwiched. In other words, the particles 58 are composed of a material that is harder than a material of the housing cover 10 and the housing body 20. Further, the bearing 32, the sleeve 34, and the shaft 35 are composed of a material that is as hard or harder than the particles 58 to mitigate risk of potential damage caused by loose or dislodged particles 58 to the bearings 32, the sleeve 34, and the shaft 35. In this embodiment, the housing cover 10 and the housing body 20 are composed of aluminum. The particles 58 are composed of a material having a hardness equal to or lower than about 65 HRC, for example below 60 HRC. In the present embodiment, the particles 58 are composed of a steel, such as a chrome steel with 5% to 10% chrome. The size of the particles 58 can range from about 10 microns to 115 microns, preferably about 115 microns. However, it is contemplated that the material and size of the particles 58 may vary in other embodiments.

As depicted in FIG. 3, each insert 50 is positioned on the connection surface 12 of the housing cover 10 around each of the cover apertures 40, aligning the insert apertures 54 with the cover apertures 40. As seen in FIG. 4, each insert 50 is oriented such that the surface 56 with the particles 58 faces towards the connection surface 12 of the housing cover 10, such that the surface 56 contacts the connection surface 12, and the surface 57 which is particle-free faces towards the connection surface 13 of the rear section 28 of the housing body 20, such that the surface 57 contacts the connection surface 13. Alternatively, each insert 50 may be oriented such that the surface 56 with the particles 58 faces towards the connection surface 13 of the rear section 28 of the housing body 20 and the surface 57 which is particle-free faces towards the connection surface 12 of the housing cover 10. In other embodiments, the orientation of the inserts 50 may vary such that some inserts 50 have the surface 56 facing towards the connection surface 12 of the housing cover 10 and some inserts 50 have the surface 56 facing towards the connection surface 13 of the rear section 28 of the housing body 20.

With reference to FIGS. 6A to 6D, an adhesive 62, such as glue, is applied to at least a part the surface 56. In some instances, the adhesive 62 is applied as drops onto the surface 56, ensuring that the surface 56 of the insert 50 adheres to the connection surface 12 of the housing cover 10 when the housing cover 10 is connected to the housing body 20. It is noted that the adhesive 62 may be applied differently in alternative embodiments, for example the adhesive 62 may be applied as a layer to the surface 56. In further alternative embodiments, the adhesive 62 may be a different material or may be omitted.

As mentioned above, when positioning the inserts 50 onto the connection surface 12 of the housing cover 10, the insert apertures 54 are aligned with the cover apertures 40. Similarly, when positioning the housing body 20 to connect with the housing cover 10, the body apertures 41 defined in the connection surface 13 of the rear section 28 are aligned with the insert apertures 54 and the cover apertures 40 so that the fasteners 22 may be inserted therethrough to fasten the housing cover 10 to the housing body 20. In this embodiment, the fasteners 22 are bolts, however any suitable type of fastener may be used. As the housing cover 10 and the housing body 20 are fastened together, the inserts 50 disposed therebetween are compressed. This causes at least some of the particles 58 on each insert 50 to penetrate the connecting surface 12 of housing cover 10, the body 52 of the insert 50, and the connection surface 13 of the rear section 28 of the housing body 20.

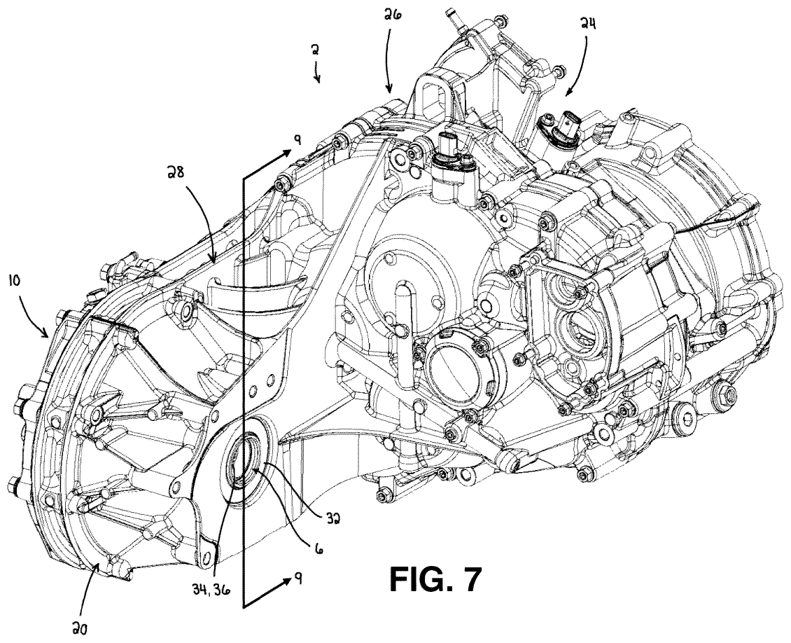

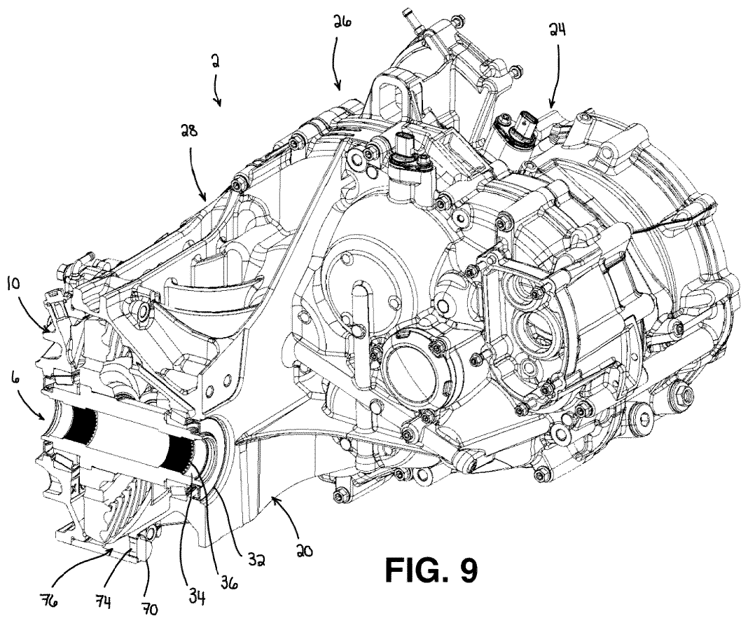

With reference to FIGS. 7 to 9, the transmission 2 further includes two magnetic threaded fasteners 70 (hereinafter fasteners 70) fastened to the housing body 20. Specifically, the housing body 20 defines magnetic fastener apertures 72 (hereinafter apertures 72), with each aperture 72 receiving a respective fastener 70. It is contemplated that, in alternative embodiments, the housing cover 10 may define the apertures 72 such that the fasteners 70 may be fastened to the housing cover 10. In further alternative embodiments, one fastener 70 may be fastened to the housing body 20 and the other fastener 70 may be fastened to the housing cover 10. As depicted in FIG. 9, each of the apertures 72 open into a volume 76 defined between the housing cover 10 and the housing body 20. When the fasteners 70 are inserted into the apertures 72, an end portion 74 of each fastener 70 is positioned within the volume 76 to capture any particles 58 which have become loose, thereby reducing and/or eliminating any loose particles 58 from becoming entrained with the lubricant, further mitigating risk of damage to the bearings 32, the sleeve 34, and the shaft 35. During maintenance of the transmission 2, the fasteners 70 may be removed from the apertures 72 and any captured particles 58 may be cleaned off or the fasteners 70 may be replaced with new clean fasteners 70. It is noted that, although two fasteners 70 and two apertures 72 are described, the number of fasteners 70 and apertures 72 may vary in other embodiments. In alternative embodiments, the two fasteners 70 may be omitted, and magnets may be connected to the inside of the housing body 20 or the housing cover 10, such as with an adhesive (e.g., glue) or any other appropriate fastening technique.

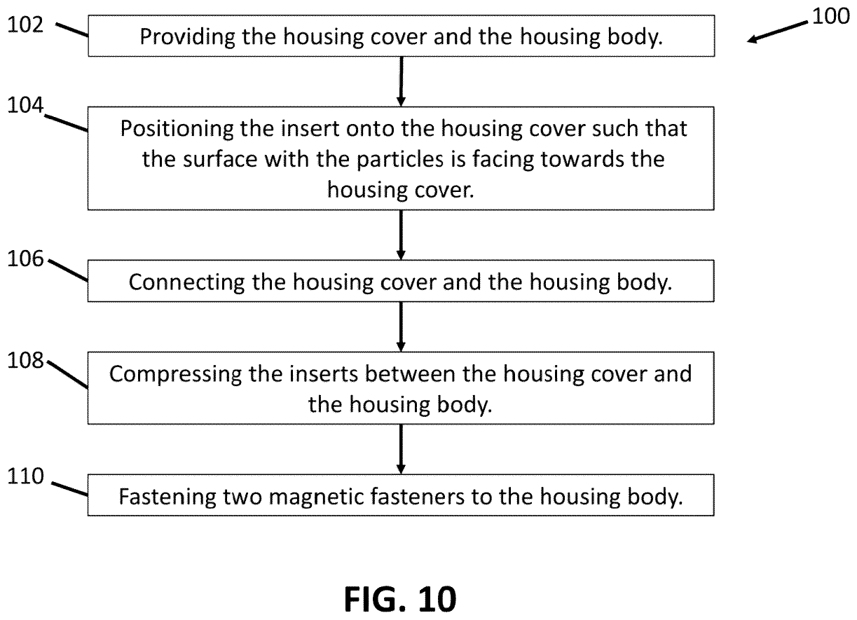

With reference to FIGS. 6A to 6D and 10, a method 100 of assembling the transmission 2 will now be described in detail. It is noted that the order of the steps of the method 100 is exemplary, and therefore the steps of the method 100 may vary in other embodiments.

The method 100 begins, at step 102 where the housing cover 10 and the housing body 20 of the transmission 2 are provided. In some embodiments, the method 100 may include applying the particles 58 to the adhesive coating 55 of the surface 56 of the inserts 50. However, it is contemplated that, in alternative embodiments, the inserts 50 may be provided with the particles 58 already adhered.

As shown in FIG. 6A, the method 100 continues with applying the adhesive 62 to at least part of the surface 56 to facilitate the insert 50 adhering to the connection surface 12 of the housing cover 10. It contemplated that, in other embodiments, this step may be omitted.

At step 104, the method 100 continues with positioning the inserts 50 onto the connection surface 12 of the housing cover 10. As shown in FIG. 6B, each insert 50 is positioned such that the surface 56 with the particles 58 and the adhesive 62 is oriented towards the connection surface 12 of the housing cover 10 and the particle-free surface 57 is oriented away from the connection surface 12 of the housing cover 10. As mentioned above, there is an insert 50 positioned around each cover apertures 40, such that the cover apertures 40 are aligned with the insert apertures 54.

The method 100 continues, at step 106, with connecting the housing cover 10 and the housing body 20. As shown in FIG. 6C, the housing cover 10 is positioned relative to the housing body 20 so that the body apertures 41 defined in the connection surface 13 of the rear section 28 are aligned with the insert apertures 54 and the cover apertures 40. The method 100 includes inserting the fasteners 22 through the respective cover apertures 40, the insert apertures 54, and the body apertures 41, thereby fastening the housing cover 10 to the housing body 20.

The method 100 continues, at step 108, with compressing the inserts 50 between the connection surface 12 of the housing cover 10 and the connection surface 13 of the housing body 20. As shown in FIG. 6D, during the fastening of the housing cover 10 and the housing body 20, the inserts 50 are compressed, causing at least some of the particles 58 of each insert 50 to penetrate the connecting surface 12 of the housing cover 10, the body 52 of the insert 50, and the connection surface 13 of the rear section 28 of the housing body 20.

Then, at step 110, the method 100 continues with fastening the two magnetic fasteners 70 to the housing body 20. Specifically, in this embodiment, the fasteners 70 are inserted into the apertures 72 defined in the housing body 20 such that the end portion 74 of each of the fasteners 70 is disposed within the respective volume 76 defined between the housing cover 10 and the housing body 20. It is contemplated that, in alternative embodiments, step 110 may be performed prior to step 106 of inserting the fasteners 22 into the cover aperture 40, the insert apertures 54, and the body apertures 41, and/or prior to step 108 of compressing the inserts 50.

It is contemplated that the method 100 could be used to assemble different portions of the transmission housing 4, such as for assembling the front section 24 to the middle section 26 and/or for assembling the middle section 26 to the rear section 28. It is also contemplated that the method 300 could be used to assemble other types of mechanical assemblies having mechanical housings with two or more components. Examples of alternative embodiments of such mechanical assemblies include, but are not limited to, an internal combustion engine having a cylinder block, cylinder head and a crankcase, an electric motor having a motor housing, and a differential having a differential housing. It is also contemplated that the method 100 could be used for assembling mechanical assemblies having two or more components that do not define a mechanical housing. Examples of alternative embodiments of such mechanical assemblies include, but are not limited to, engine mounts, interfaces between suspension struts and chassis, and panel and frame assemblies.

Modifications and improvements to the above-described embodiments of the present invention may become apparent to those skilled in the art. The foregoing description is intended to be exemplary rather than limiting. The scope of the present technology is therefore intended to be limited solely by the appended claims.

What is claimed is:

1. A transmission for a vehicle, the transmission comprising:
a housing body having a body connection surface;
a housing cover having a cover connection surface, the housing cover connected to the housing body such that the body connection surface faces the cover connection surface;
a friction-enhancing insert having:
a compressible body having:
a first surface contacting one of the body connection surface and the cover connection surface;
a second surface contacting an other one of the body connection surface and the cover connection surface; and
particles, the particles being disposed on at least a portion of the first surface prior to the friction-enhancing insert being compressed,
the particles being harder than a material of the housing body and the housing cover;
the friction-enhancing insert being compressed between the body connection surface and the cover connection surface such that at least some of the particles penetrate the compressible body, the body connection surface, and the cover connection surface; and
at least one magnetic threaded fastener fastened to at least one of the housing body and the housing cover, a portion of at least one magnetic threaded fastener being disposed in a volume defined between the housing body and the housing cover.

2. The transmission of claim 1, wherein:
the first surface contacts the cover connection surface; and
the second surface contacts the body connection surface.

3. The transmission of claim 1, wherein:
the material of the housing body and the material of the housing cover are aluminum; and
the particles are steel particles.

4. The transmission of claim 1, wherein:
the body connection surface defines a body aperture;
the cover connection surface defines a cover aperture;
the friction enhancing insert defines an insert aperture extending between the first surface and the second surface;
the insert aperture, the body aperture, and the cover aperture being aligned with one another; and
the transmission further includes a fastener inserted through the cover aperture, the body aperture, and the insert aperture, thereby fastening the housing cover to the housing body.

5. The transmission of claim 4, wherein the friction-enhancing insert is a ring.

6. The transmission of claim 1, wherein an adhesive coating is applied to at least the portion of the first surface and the particles are adhered to the adhesive coating.

7. The transmission of claim 1, wherein the first surface comprises an adhesive applied to at least a part of the first surface to adhere the first surface to the one of the body connection surface and the cover connection surface.

8. The transmission of claim 1, further comprising:
a bearing received in at least one of the housing body and the housing cover; and
a shaft supported by the bearing;
wherein a material of the bearing and a material of the shaft are as hard or harder than the particles.

9. The transmission of claim 1, wherein the at least one magnetic threaded fastener is two magnetic threaded fasteners.

10. The transmission of claim 1, wherein the portion of the at least one magnetic threaded fastener is at an end of the at least one magnetic threaded fastener.

11. A method of assembling a transmission of a vehicle, the method comprising:
providing a housing body of the transmission, the housing body having a body connection surface;
providing a housing cover of the transmission, the housing cover having a cover connection surface;
positioning a first surface of a friction-enhancing insert to contact one of the body connection surface and the cover connection surface, the friction-enhancing insert having a compressible body, the first surface having:
particles, the particles being disposed on at least a portion of the first surface,
the particles being harder than a material of the housing body and the housing cover;
connecting the housing body and the housing cover such that a second surface of the friction-enhancing insert contacts an other one of the body connection surface and the cover connection surface;
compressing the friction-enhancing insert such that at least some of the particles penetrate the compressible body, the body connection surface, and the cover connection surface; and
fastening at least one magnetic threaded fastener to at least one of the housing body and the housing cover, such that a portion of the at least one magnetic threaded fastener is disposed in a volume defined between the housing body and the housing cover.

12. The method of claim 11, wherein:
the first surface contacts the cover connection surface; and
the second surface contacts the body connection surface.

13. The method of claim 11, further comprising applying an adhesive to at least a part of the first surface of the friction-enhancing insert, such that the adhesive adheres to the one of the body connection surface and the cover connection surface.

14. The method of claim 11, wherein:
the body connection surface defines a body aperture;
the cover connection surface defines a cover aperture;
the friction-enhancing insert defines an insert aperture extending between the first surface and the second surface;
the positioning the first surface of the friction-enhancing insert to contact one of the body connection surface and the cover connection surface comprises:
aligning the insert aperture with the body aperture and the cover aperture; and
the connecting the housing body and the housing cover comprises:
inserting a fastener through the cover aperture, the insert aperture, and the body aperture; and
fastening the housing cover to the housing body with the fastener.

15. The method of claim 11, wherein the fastening at least one magnetic threaded fastener to at least one of the housing body and the housing cover comprises fastening two magnetic threaded fasteners to at least one of the housing body and the housing cover.

16. The method of claim 11, wherein the portion of the at least one magnetic threaded fastener is at an end of the at least one magnetic threaded fastener.

17. The method of claim 11, further comprising:
placing a bearing in at least one of the housing body and the housing cover, and
inserting a shaft into the bearing;
wherein a material of the bearing and a material of the shaft are as hard or harder than the particles.
